(19) United States
(12) Patent Application Publication
(10) Pub. No.: US 2026/0273412 A1
(43) Pub. Date: Sep. 17, 2026

(54) Interaction Processing Method and Apparatus for Virtual Scene

(71) Applicant: Tencent Technology (Shenzhen) Company Limited, Shenzhen (CN)

(72) Inventor: Ziqi Wei, Shenzhen (CN)

(21) Appl. No.: 19/675,674

(22) Filed: May 13, 2026

Related U.S. Application Data
(63) Continuation of application No. PCT/CN2025/101704, filed on Jun. 18, 2025.

(30) Foreign Application Priority Data
Jul. 19, 2024 (CN) 202410977690X

(51) Int. Cl. A63F 13/57; A63F 13/52; A63F 13/5372; A63F 13/67; A63F 13/798

(52) U.S. Cl. CPC A63F 13/57; A63F 13/52; A63F 13/5372; A63F 13/67; A63F 13/798

(57) ABSTRACT

This application is related to an interaction processing method and apparatus for a virtual scene. The method comprises: displaying a first virtual scene, the first virtual scene including at least one player character (PC) and a non-player character (NPC). The method also comprises controlling the at least one PC to interact with the NPC; and displaying an interaction result in response to completion of the interaction. The interaction result includes a plurality of interaction metrics. The interaction result is configured for determining a virtual resource distributed to each PC. The virtual resource includes a plurality of parts in one-to-one correspondence with the plurality of interaction metrics, and a quantity of each part is positively correlated with a ranking of the PC in an interaction metric corresponding to the part.

### RELATED APPLICATIONS

This application claims priority to PCT/CN2025/101704, filed on June 18, 2025, which claims priority to Chinese Patent Application No. 202410977690X filed on July 19, 2024, each of which is incorporated herein by reference in its entirety.

### FIELD OF THE TECHNOLOGY

This application relates to the field of Internet technologies, and in particular, to an interaction processing method and apparatus for a virtual scene, an electronic device, a computer-readable storage medium, and a computer program product.

### BACKGROUND OF THE DISCLOSURE

Display technologies based on graphics processing hardware have expanded channels for perceiving an environment and obtaining information. In particular, display technologies for virtual scenes enable diversified interactions between virtual objects (such as a player character (PC) and a non-player character (NPC)) controlled by users (or referred to as players) or artificial intelligence (AI) according to practical application requirements, and are applicable to various typical application scenarios. For example, the display technology can simulate a realistic combat process between virtual objects in a virtual scene such as a game.

In the related art, a game system allocates virtual resources to overall metrics of players in a virtual scene. However, this allocation manner tends to concentrate virtual resources on virtual objects with higher overall metrics. These objects are unable to fully utilize the allocated virtual resources, and some virtual objects who need virtual resources are unable to obtain virtual resources due to low overall metrics. This not only leads to a mismatch between the virtual resources and actual needs of the virtual objects, but also results in unnecessary resource consumption for computing the virtual resources by a computer system.

### SUMMARY

In view of this, examples of this application provide an interaction processing method and apparatus for a virtual scene, an electronic device, a computer-readable storage medium, and a computer program product, to improve a matching degree between a player character (PC) and a virtual resource, and improve utilization of the virtual resource.

Technical solutions of the examples of this application are implemented as follows:

Examples of this application provide an interaction processing method for a virtual scene, which is applied to an electronic device and comprises: displaying a first virtual scene, the first virtual scene including at least one PC and a non-player character (NPC); controlling the at least one PC to interact with the NPC; and displaying an interaction result in response to completion of the interaction, the interaction result including a plurality of interaction metrics. The method further comprises determining, based on the interaction result, a virtual resource distributed to the at least one PC. The virtual resource include a plurality of parts in one-to-one correspondence with the plurality of interaction metrics, and a quantity of each part is positively correlated with a ranking of the at least one PC in an interaction metric corresponding to the part.

Examples of this application provide an interaction processing apparatus for a virtual scene, which includes: a display module, configured to display a first virtual scene, the first virtual scene including at least one PC and an NPC; and a control module, configured to control the at least one PC to interact with the NPC, the display module being further configured to display an interaction result in response to completion of the interaction, the interaction result including a plurality of interaction metrics. The interaction result can be configured for determining a virtual resource distributed to each PC. The virtual resource include a plurality of parts in one-to-one correspondence with the plurality of interaction metrics, and a quantity of each part is positively correlated with a ranking of the PC in an interaction metric corresponding to the part.

Examples of this application provide an electronic device, which includes: a memory, configured to store executable instructions; and a processor, configured to implement, when executing the executable instructions stored in the memory, the interaction processing method for a virtual scene according to the examples of this application.

Examples of this application provide a computer-readable storage medium, having computer-executable instructions stored therein, the computer-executable instructions, when executed by a processor, implementing the interaction processing method for a virtual scene according to the examples of this application.

Examples of this application provide a computer program product, including a computer program or computer-executable instructions, the computer program or the computer-executable instructions, when executed by a processor, implementing the interaction processing method for a virtual scene according to the examples of this application.

The examples of this application have the following beneficial effects: The virtual resource distributed to the PC is determined based on the interaction result between the PC and the NPC. In addition, the virtual resource includes the plurality of parts in one-to-one correspondence with the plurality of interaction metrics, and the quantity of each part is positively correlated with the ranking of the PC in the corresponding interaction metric. This enables the virtual resource to precisely match performance of the PC on the specific interaction metric, improves a matching degree between the virtual resource and rankings of the PC in different interaction metrics, and enhances pertinence and rationality of resource allocation. Corresponding resource allocation is generated based on the rankings of the interaction metrics, and complex weighted calculation does not need to be performed for the PC from an overall interaction metric dimension. This reduces an amount of invalid computation of the computer system in the resource allocation process, improves computational efficiency, and reduces resource consumption. Because resource allocation is independently calculated based on the interaction metrics, the virtual resources corresponding to the interaction metrics may be directly stored, to reduce data redundancy caused by an unused virtual resource allocated to a PC with an excessively high overall metric.

### BRIEF DESCRIPTION OF THE DRAWINGS

FIG. 1 is a schematic architectural diagram of an interaction processing system 100 for a virtual scene according to an example of this application.

FIG. 2 is a schematic structural diagram of an electronic device 500 according to an example of this application.

FIG. 3 is a first schematic flowchart of an interaction processing method for a virtual scene according to an example of this application.

FIG. 4 is a second schematic flowchart of an interaction processing method for a virtual scene according to an example of this application.

FIG. 5 is a third schematic flowchart of an interaction processing method for a virtual scene according to an example of this application.

FIG. 6 is a schematic diagram of a first application scenario of an interaction processing method for a virtual scene according to an example of this application.

FIG. 7 is a schematic diagram of a second application scenario of an interaction processing method for a virtual scene according to an example of this application.

FIG. 8 is a schematic diagram of a third application scenario of an interaction processing method for a virtual scene according to an example of this application.

FIG. 9 is a schematic diagram of a fourth application scenario of an interaction processing method for a virtual scene according to an example of this application.

FIG. 10 is a schematic diagram of a fifth application scenario of an interaction processing method for a virtual scene according to an example of this application.

FIG. 11 is a fourth schematic flowchart of an interaction processing method for a virtual scene according to an example of this application.

The terms "first" and "second" are merely used to distinguish between different solutions, and are not intended to indicate priorities of the solutions or priorities in an implementation process.

### DETAILED DESCRIPTION

To make the objectives, technical solutions, and advantages of this application clearer, the following describes this application in further detail with reference to the accompanying drawings. The described examples are not construed as limitations on this application. All other examples obtained by a person of ordinary skill in the art without creative efforts fall within the scope of protection of this application.

In the following description, the term "some examples" describes subsets of all possible examples, and "some examples" may be the same subset or different subsets of all the possible examples, and can be combined with each other without conflict.

In the examples of this application, user information and other related data (such as, data of a player-controlled game character) are involved. When the examples of this application are applied to specific products or technologies, user permission or consent is required, and collection, use, and processing of the related data need to comply with relevant laws, regulations, and standards of relevant countries and regions.

In the following description, the terms "first\second..." are merely used to distinguish between similar objects and do not imply a specific order for the objects. Where permitted, the specific order or sequence denoted by "first\second..." may be interchanged to allow the examples of this application described herein to be implemented in an order other than those illustrated or described herein.

Unless otherwise defined, all technical and scientific terms used herein have the same meaning as commonly understood by a person of ordinary skill in the art to which this application belongs. Terms used herein are merely intended to describe the examples of this application, but are not intended to limit this application.

Before the examples of this application are described in further detail, nouns and terms involved in the examples of this application are described, and the nouns and terms in the examples of this application are applicable to the following explanations.
(1) "In response to": it is configured for representing a condition or state on which a performed operation depends. When the condition or state on which the performed operation depends is satisfied, one or more performed operations may be performed in real time, or may be performed with a set delay. Unless otherwise specified, a plurality of performed operations are not limited to an execution sequence.
(2) Virtual scene: it is a scene displayed (or provided) when an application program is run on a terminal device. The scene may be a simulated environment of a real world, or may be a semi-simulated and semi-fictional virtual environment, or may be a completely fictional virtual environment. The virtual scene may be any one of a two-dimensional virtual scene, a 2.5-dimensional virtual scene, or a three-dimensional virtual scene. A dimension of the virtual scene is not limited in the examples of this application. For example, the virtual scene may include the sky, the land, the ocean, or the like. The land may include environmental elements such as the desert and a city. A user (or referred to as a player) may control a player character (PC) to move in the virtual scene.
(3) PC: it refer to characters controlled by a player in a virtual scene, which is often a figure in a storyline of a game or a protagonist who drives a plot forward. The PC may have a series of attributes, skills, and characteristics, which are typically determined by rules set by the game, including but not limited to health points, attack power, defense, magic abilities, and the like. In the game, a player can obtain experience points, equipment, and skill upgrades by controlling the PC to execute tasks, solve problems, defeat monsters, or the like, to enable continuous character development and advance the storyline of the game.
(4) Non-player character (NPC): it refers to a character controlled by game artificial intelligence (AI) in a virtual scene, rather than a character controlled by a player. The NPC is often employed to fill in a game world, provide a background of a storyline, execute a task for a player, or serve as an object for player interaction. The design of the NPC typically incorporates a level of intelligence, which allows the NPC to exhibit spontaneous behaviors within a game world. This enhances realism and interactivity of the game. A behavior mode of the NPC may be controlled by a simple script, or may be implemented by using a more complex AI system, to enable the NPC to interact and react in a more natural manner in the game world.
(5) Auto chess game: it is a type of game where pieces are placed for matches. Players engage in a match by using the pieces for combat, and achieve victory by defeating an opponent. For example, players may purchase pieces to arrange the pieces and then win a match by playing against each other. A combat manner may be generally divided into two forms. One form is player versus player rounds. For example, it is assumed that a total of eight players exist, who are divided into four group for 1v1 combat. Combat opponents are randomly matched, and defeating the opponents inflicts damage. It is assumed that game characters controlled by the players respectively have 100 health points, a player whose health point reaches 0 is eliminated, and the top 4 players are considered winners and receive a ranking-based increase in points corresponding to tier of the players. The other format is player versus monster rounds, which are typically configured for obtaining resources and enhancing combat power of players, such as obtaining equipment or gold coins.
(6) Cloud game: it is also referred to as gaming on demand. To be specific, a game program is deployed in a server, an instance of the game program (briefly referred to as a game instance) is run, the game instance transmits game data outputted in the running process to a page of a browser of a user terminal, and the page invokes a media component of the browser to decode the game data, and renders a real-time game picture in a game process based on a decoding result. When monitoring an operation performed by a user in the game picture, the page reports the operation to the game instance run in the server. When receiving game data of a response operation generated by the game instance, the page repeats the decoding and rendering process, to present a change in the game picture based on the operation of the user on the page.
   A cloud game is an online game technology based on a cloud computing technology. The cloud gaming technology enables a thin client with limited graphics processing and data operation capabilities to run a high-quality game. In a cloud game scenario, the game is not run in the user terminal (such as a player game terminal), but is run in the cloud server, and the cloud server renders a game scene into an audio and video stream and transmits the audio and video stream to the user terminal via a network. In this way, the user terminal does not need to have a powerful graphic operation capability and data processing capability, and only needs to have a basic streaming media playback capability and a capability to obtain the instructions inputted by the player and transmit the instructions to the cloud server.
(7) Interaction metric: it refers to a measurable parameter configured for quantifying and measuring a particular performance dimension in an interaction process between a PC and an NPC in a virtual scene, and covers a key data dimension of various interaction behaviors such as combat and cooperation. In a simulated management virtual scene, the interaction metric may be a quantity of transactions between the PC and the NPC or an on-time rate for completing orders. In an adventure virtual scene, the interaction metric may be an attack hit rate of the PC against the NPC opponent or a quantity of successful evasions of opponent attacks.
(8) Virtual resource: it refers to an item or a numerical value that has a virtual value and that is rewarded to a player based on performance of a PC during interaction after the interaction in a virtual scene is completed, and may be configured for in-game activities such as character development and equipment obtaining. After the interaction in the virtual scene is completed, the PC may obtain experience points, to enable the character to level up and unlock new skills; or may obtain rare materials that are configured for crafting exclusive equipment. In a social virtual scene, the player may obtain an honorary resource such as a virtual medal and a title, to improve impact of the character in a virtual community. The gold coins, experience points, materials, medal, and the like all belong to virtual resources.
(9) Interaction result: it is a summary presentation of an entire interaction process after the interaction between a PC and an NPC is completed, includes a plurality of interaction metrics reflecting interaction performance of the PC and a ranking corresponding to the plurality of interaction metrics, and serves a basis for distributing a virtual resource. A virtual combat scene of multi-player arena is used as an example. The interaction result may present interaction metrics such as a quantity of kills, a quantity of deaths, and a quantity of assists of each PC, and generate a comprehensive ranking based on the metrics. For example, a player A ranks first in the quantity kills and third in the quantity assists. Based on this interaction result, corresponding virtual resources are distributed to the player A according to preset rules.
(10) Human-computer interaction interface: it refers to an interface configured to provide a human-computer interaction function/display a virtual scene.

For example, a graphical user interface (GUI) is presented, including, for example, an augmented reality (AR) interface, a virtual reality (VR) interface, a voice user interface (VUI), an interactive projection interface (displaying information on a plane using a projection technology), an eye movement detection interface (an interface controlled by detecting a line of sight of a user), a holographic interface (a three-dimensional hologram formed by projecting an image using a holographic projection technology, allowing stereoscopic visuals to be viewed without special glasses), a multi-modal interface (an interaction interface combining a plurality of interaction manners, such as touch, vision, and hearing), and a Brain-Machine Interface (BMI).

An auto chess game is used as an example. In the related art, for a player versus monster round, a player may independently battle against a monster to obtain a corresponding reward, and the reward drops randomly. Rewards that drop for eight players are determined purely based on luck, with some variation, but an overall difference is not significant. That is, in the related art, the combat between the player and the monster is independent, and the dropping reward content does not differ significantly, resulting in a reduced sense of contest among players.

In view of this, examples of this application provide an interaction processing method and apparatus for a virtual scene, an electronic device, a computer-readable storage medium, and a computer program product, to diversify virtual resource distribution manners in a virtual scene, and enhance a sense of contest and gaming experience of a player. The following describes an electronic device provided in the examples of this application. The electronic device provided in the examples of this application may be implemented as a terminal device (corresponding to a standalone game), or may be collaboratively implemented by a terminal device and a server (corresponding to an online game). A description is made below by using an example in which a server and a terminal device collaboratively implement the interaction processing method for a virtual scene provided in the examples of this application.

Before an architecture of an interaction processing system for a virtual scene provided in the examples of this application is described, a game mode involved in the examples of this application is described. The solution collaboratively implemented by the terminal device and the server mainly involves two game modes, which are a local game mode and a cloud game mode, respectively. The local game mode means that the terminal device and the server collaboratively run game processing logic, a part of an operation instruction inputted by a player on the terminal device is processed by the game logic run on the terminal device, and the other part of the operation instruction is processed by the game logic run on the server. In addition, the game logic run on the server is typically more complex, and needs greater computational power. The cloud game mode means that the operation instruction is completely processed by the logic run on the server (such as a cloud server), and the cloud server renders game scene data into an audio and video stream, and transmits the audio and video stream to the terminal device via a network for display. In other words, the terminal device only needs to have a basic streaming media playback capability and a capability to obtain the operation instruction of the player and transmit the operation instruction of the player to the server.

The following describes the architecture of the interaction processing system for a virtual scene provided in the examples of this application.

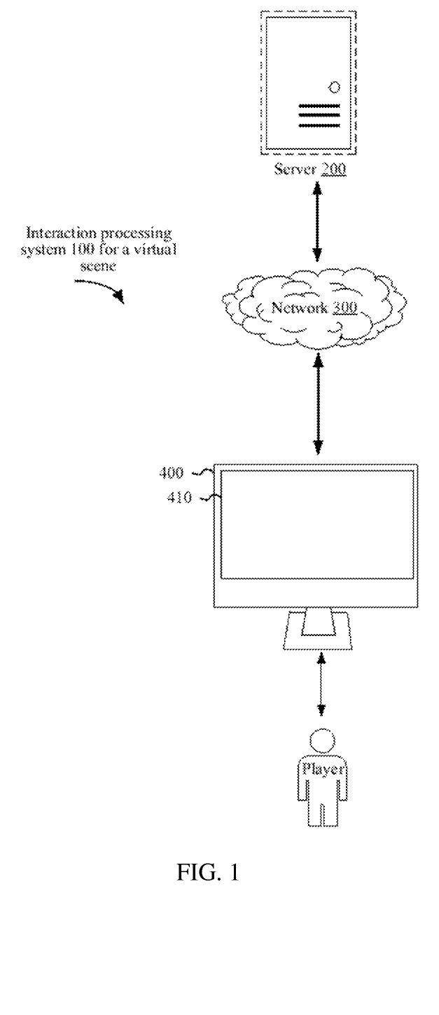

For example, FIG. 1 is a schematic architectural diagram of an interaction processing system 100 for a virtual scene according to an example of this application. As shown in FIG. 1, the interaction processing system 100 for a virtual scene includes: a server 200 (such as a game backend server), a network 300, and a terminal device 400. The network 300 may be a local area network, a wide area network, or a combination thereof. The terminal device 400 is a terminal device associated with a player. A client 410 runs on the terminal device 400. The client 410 may be any type of client, including, for example, an auto chess game client, a role-playing game client, a virtual scene client, and a browser.

In some examples, a first virtual scene (such as a virtual scene in which an NPC is located) may be displayed on a human-computer interaction interface of the client 410. The first virtual scene may include at least one PC and the NPC (such as a boss in a game). After detecting that all PCs are teleported to the first virtual scene, the client 410 may control the at least one PC to interact with the NPC. Subsequently, the client 410 displays an interaction result after detecting completion of the interaction. The interaction result may include a plurality of interaction metrics (such as outputted damage values and survival duration). The interaction result may be configured for determining a virtual resource (e.g., a virtual reward) distributed to each PC, the virtual resource may include a plurality of parts in one-to-one correspondence with the plurality of interaction metrics, and a quantity of each part may further be positively correlated with a ranking of the PC in an interaction metric corresponding to the part. In other words, a higher ranking of the PC indicates a larger quantity of virtual resources that can be obtained. In this way, virtual resource distribution manners are diversified, and a sense of contest and gaming experience of the player are enhanced.

The virtual scene in the interaction processing method for a virtual scene provided in the examples of this application may be outputted completely based on the terminal device, or may be outputted collaboratively based on the terminal device and the server. For example, calculation and output of related data of the virtual scene may completely rely on computing power of graphic processing hardware of the terminal device 400. A type of the graphic processing hardware includes a central processing unit (CPU) and a graphics processing unit (GPU). For example, when forming a visual perception of the virtual scene, the terminal device 400 calculates data required for display through graphics computing hardware, loads, parses, and renders display data, and outputs video frames that enable visual perception of the virtual scene through graphics output hardware. For example, two-dimensional video frames are presented on a display screen of a smartphone, or video frames achieving a three-dimensional display effect are projected onto lenses of AR/VR glasses. In addition, to enrich the perceptual experience, the terminal device 400 may further create one or more of an auditory perception, a tactile perception, a motion perception, and a taste perception through different hardware.

Alternatively, the virtual scene may be calculated based on computing power of the server 200 and outputted by the terminal device 400. For example, when a visual perception of the virtual scene, the server 200 calculates related display data (such as scene data) of the virtual scene, and transmits the display data to the terminal device 400 via the network 300. The terminal 400 loads, parses, and renders the calculated display data through the graphics computing hardware, and outputs the virtual scene through the graphics output hardware to form the visual perception, for example, two-dimensional video frames may be presented on a display screen of a smartphone, or display video frames achieving a three-dimensional display effect are projected onto lenses of AR/VR glasses. Perceptions of the virtual scene may be formed through corresponding output hardware of the terminal device 400. For example, an auditory perception is formed through a microphone, and a tactile perception is formed through a vibrator.

In addition, the server 200 in FIG. 1 may be an independent physical server, or may be a server cluster or distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and AI platform. The terminal device 400 may be, but is not limited to, a smartphone, a tablet computer, a notebook computer, a desktop computer, a smart speaker, a smartwatch, an in-vehicle terminal, or the like. The terminal device 400 and the server 200 may be directly or indirectly connected by using a wired or wireless communication protocol. This is not limited in the examples of this application.

In some examples, the terminal or the server may implement the interaction processing method for a virtual scene provided in the examples of this application by running various computer-executable instructions or a computer program. For example, the computer-executable instructions may be a microprogram-level command, machine instructions, or software instructions. The computer program may be a native program or a software module in an operating system; may be a native application (APP), e.g., a program that needs to be deployed in the operating system to run, such as an auto chess game APP; or may be a mini program that may be embedded in any APP, e.g., a program that only needs to be downloaded into a browser environment to run. The computer executable instructions may be instructions in any form, and the computer program may be an application program, a module, or a plug-in in any form.

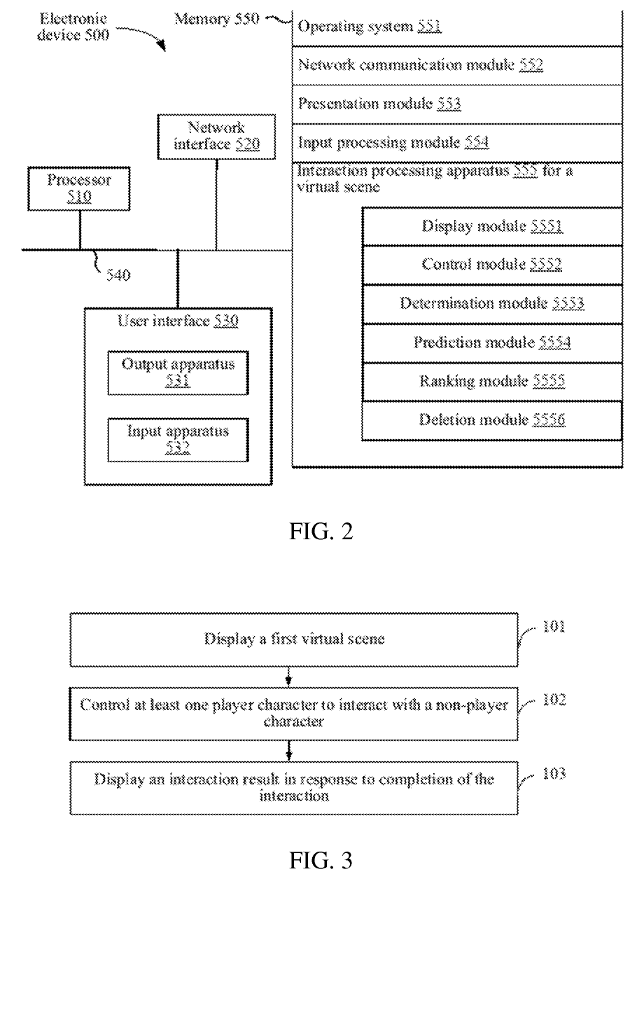

The following describe a structure of the electronic device provided in the examples of this application. An example in which the electronic device is a terminal device is used. FIG. 2 is a schematic structural diagram of an electronic device 500 according to an example of this application. The electronic device 500 shown in FIG. 2 includes: at least one processor 510, a memory 550, at least one network interface 520, and a user interface 530. The components in the terminal device 500 are coupled together through a bus system 540. The bus system 540 is configured to implement connection and communication between the components. In addition to a data bus, the bus system 540 further includes a power bus, a control bus, and a state signal bus. However, for clarity of description, all types of buses in FIG. 2 are marked as the bus system 540.

The processor 510 may be an integrated circuit chip having a signal processing capability, such as a general purpose processor, a digital signal processor (DSP), another programmable logic device, discrete gate or transistor logic device, or discrete hardware component. The general purpose processor may be a microprocessor, any conventional processor, or the like.

The user interface 530 includes one or more output apparatuses 531 capable of presenting media content, including one or more speakers and/or one or more visual display screens. The user interface 530 further includes one or more input apparatuses 532, including a user interface component that facilitates user input, such as a keyboard, a mouse, a microphone, a touchscreen, a camera, and another input button and control.

The memory 550 may be a removable memory, a non-removable memory, or a combination thereof. Exemplary hardware devices include a solid-state drive, a hard disk drive, an optical disk drive, and the like. In an example, the memory 550 may include one or more storage devices physically remote from the processor 510.

The memory 550 includes a volatile memory or a non-volatile memory, or may include both a volatile memory and a non-volatile memory. The non-volatile memory may be a read-only memory (ROM), and the volatile memory may be a random-access memory (RAM). The memory 550 described in the examples of this application is intended to include any suitable type of memory.

In some examples, the memory 550 is capable of storing data to support various operations. Examples of the data include a program, a module, and a data structure or subsets or supersets thereof, which are For example described below.

An operating system 551 includes system programs configured for processing various basic system services and performing hardware-related tasks, such as a framework layer, a core library layer, and a drive layer, and is configured to implement various basic services and process hardware-based tasks.

A network communication module 552 is configured to reach another computing device through one or more (wired or wireless) network interfaces 520. Exemplary network interfaces 520 include: Bluetooth, Wireless Fidelity (Wi-Fi), a universal serial bus (USB), and the like.

A presentation module 553 is configured to enable presentation of information through the one or more output apparatuses 531 (such as a display screen or a speaker) associated with the user interface 530 (such as a user interface configured for operating a peripheral device and displaying content and information).

An input processing module 554 is configured to detect one or more user inputs or interactions from one of the one or more input apparatuses 532, translate the detected inputs or interactions.

In some examples, the apparatus provided may be implemented by using software. FIG. 2 shows an interaction processing apparatus 555 for a virtual scene that is stored in the memory 550. The interaction processing apparatus for a virtual scene may be software in the form of a program, a plug-in, or the like, and includes the following software modules: a display module 5551, a control module 5552, a determination module 5553, a prediction module 5554, a ranking module 5555, and a deletion module 5556. These modules are logical modules, and may be combined in different manners or further divided based on implemented functions. In FIG. 2, for convenience of expression, all the foregoing modules are shown at once, but it is not to be deemed that the implementation in which the interaction processing apparatus 555 for a virtual scene may include only the display module 5551 and the control module 5552 is excluded, and functions of the modules are described below.

The following describes the interaction processing method for a virtual scene provided in the examples of this application in detail below with reference to exemplary application and implementations of the terminal device provided in the examples of this application.

For example, FIG. 3 is a first schematic flowchart of an interaction processing method for a virtual scene according to an example of this application. A description is made with reference to operations shown in FIG. 3.

The method shown in FIG. 3 may be performed by various forms of computer programs run on the terminal device. The computer program is not limited to a client, and may be, for example, the operating system, software module, script, or mini program described above. Therefore, examples provided below using a client are not construed as limiting the examples of this application. In addition, for ease of description, a client running on the terminal device and a client running on the terminal device are not specifically distinguished below.

Operation 101: Display a first virtual scene.

Herein, the first virtual scene may include at least one PC and an NPC. For example, the first virtual scene may refer to a virtual scene in which the NPC (such as a boss in a game) is located, and the at least one PC (which may be, for example, a candidate PC selected by a player in a second virtual scene) is teleported to the virtual scene (e.g., the first virtual scene) in which the NPC is located, to interact with the NPC.

In some examples, the at least one PC may include a first PC (such as, a game character currently controlled by the player). Before operation 101 is performed, the following processing may further be performed: displaying a second virtual scene before each round of interaction starts, the second virtual scene including at least one candidate PC; and using a selected candidate PC as the first PC in response to a selection operation for the at least one candidate PC; or automatically selecting one candidate PC from the at least one candidate PC as the first PC in response to not receiving the selection operation for the at least one candidate PC within set duration (such as 30 seconds). Correspondingly, operation 101 may be implemented in the following manner: switching from the second virtual scene to the first virtual scene, and displaying the first PC and the NPC in the first virtual scene.

For example, an auto chess game is used as an example. Before each round of interaction (such as battling against a boss in the game) starts, that is, during a preparation round prior to a boss battle round, a player may select a virtual piece (e.g., the PC) from a virtual chessboard (e.g., the second virtual scene) to participate in battling against the boss (e.g., the NPC). For example, a plurality of candidate virtual pieces (which are assumed to be a piece A, a piece B, and a piece C, respectively) may be displayed in the virtual chessboard for selection by the player. It is assumed that the player selects the piece A from the plurality of candidate virtual pieces. For example, a click operation of the player for the piece A is received, the piece A may be used as a piece (e.g., the first PC) that needs to battle against the boss. After the player selects the piece A, the piece A may further be displayed in a highlighted state, to prompt the player that the piece A is currently selected, and subsequently, the piece A may be teleported to a scene (e.g., the first virtual scene) in which the boss is located in the game.

A piece selected by another player in a corresponding virtual chessboard is also teleported to the scene in which the boss is located in the game. For example, it is assumed that a player 2 selects the piece B in a corresponding virtual chessboard, the piece B is also teleported to the scene in which the boss is located in the game, to battle against the boss together with the piece A.

In addition, if the player does not select any piece in the preparation round, a piece may be automatically selected from the plurality of candidate virtual pieces included in the virtual chessboard as a piece that needs to battle against the boss. For example, a piece may be randomly selected from the plurality of candidate virtual pieces, a piece with a strongest comprehensive attribute may be automatically selected from the plurality of candidate virtual pieces, or a piece selected last time or a piece with a highest historical selection frequency may be automatically selected from the plurality of candidate virtual pieces. This is not specifically limited in the examples of this application.

The examples of this application not only support proactive selection of the first PC by the player, to grant the player room for autonomous decision-making, but also provides an automatic selection mechanism for a case that the player fails to perform an operation in time, to avoid interruptions in interactions caused by inaction of the player and enhance fluidity of player participation in interactions. Character selection and scene switching are quickly completed by defining a transition process between selection of the candidate PC in the second virtual scene and the interaction in the first virtual scene, to shorten waiting time of the player and ensure efficiency progression of each round of interaction. A plurality of policies for proactive selection can adapt to different player needs and game scenes, to enhance overall gaming experience of the player.

In some other examples, following the foregoing example, after the second virtual scene is displayed, the following processing may be further performed: highlighting, for a target candidate PC in the at least one candidate PC, the target candidate PC in the second virtual scene, the target candidate PC being a candidate PC satisfying a recommendation condition, and the recommendation condition including at least one of the following: an attribute value of a PC reaching an attribute value threshold, a level of the PC reaching a level threshold, or a quantity of equipment of the PC reaching a quantity threshold.

For example, the auto chess game is used as an example. To improve selection efficiency of the player, after the virtual chessboard is displayed, a virtual piece that satisfies the recommendation condition in the virtual chessboard may be further highlighted. For example, the virtual piece that satisfies the recommendation condition may be highlighted in a sparkling manner.

According to the examples of this application, the target candidate PC that satisfied the recommendation condition is automatically screened out and presented in a highlighting manner, which can help the player quickly lock, from the plurality of candidate PCs, the target candidate PC whose dimension reaches a threshold, to facilitate selection by the player, reduce time required for selecting a piece or viewing character attributes one by one. In this way, the player can complete character selection more quickly, to engage in the interaction in the first virtual scene, which accelerates game progress, and also improves gaming experience of the player.

In some examples, the at least one PC may include the first PC (such as the game character currently controlled by the player) and at least one second PC (such as a game character controlled by another player). Before operation 101 is performed, the following processing may further be performed: displaying the second virtual scene before each round of interaction starts, the second virtual scene including the at least one candidate PC; invoking, for each candidate PC, a machine learning model to perform prediction based on feature data (such as attack power, defense power, a skill type, and a health point) of the candidate PC, feature data of the at least one second PC, and feature data of the NPC included in the first virtual scene, to obtain a probability that the candidate PC is selected, the prediction being performed with the goal of defeating the NPC by the candidate PC and the at least one second PC; and using a candidate PC with a highest probability of being selected as the first PC. In this way, the AI-based manner helps the player automatically select a PC with a highest probability of defeating the NPC, to avoid resource waste caused by repeated trial and error of the player.

For example, the feature data of the candidate PC includes, but is not limited to, at least one of the following: attack power, defense power, a skill type (such as area-of-effect damage, healing, or crowd control), a health point, an attack speed, skill cooldown time, an elemental advantage relationship (such as an ice attribute bonus against a fire attribute opponent), and the like. The feature data of the second PC includes, but is not limited to, at least one of the following: a group attribute (such as average attack power), team skill synergy (such as presence of group healing support), and character occupation distribution (a proportion of damage dealers or supports). The feature data of the NPC includes, but is not limited to, at least one of the following: a health point, attack power, a skill mechanism (such as area-of-effect damage or an invincibility phases), an elemental weakness, and a defense type (such as a physical or magical resistance). The machine learning model may be any type of neural network model, including, for example, a convolutional neural network model, a deep learning neural network model, and a support vector machine. A type of the machine learning model is not specifically limited in the examples of this application.

In some examples, the "invoking a machine learning model to perform prediction based on feature data of the candidate PC, feature data of the at least one second PC, and feature data of the NPC included in the first virtual scene, to obtain a probability that the candidate PC is selected" may be implemented by performing the following processing: embedding the feature data of the candidate PC, to obtain a first vector; embedding the feature data of the at least one second PC, to obtain a second vector; embedding the feature data of the NPC included in the first virtual scene, to obtain a third vector; fusing the first vector, the second vector, and the third vector into a to-be-predicted vector; performing feature extraction on the to-be-predicted vector by using a plurality of layers of neurons in the machine learning model, to obtain a deep feature of the to-be-predicted vector; and performing linear transformation on the deep feature, to map the deep feature to the probability that the candidate PC is selected.

For example, the machine learning model is obtained through training by performing the following processing: obtaining feature data of a historical candidate PC, feature data of at least one historical second PC, and feature data of a historical NPC included in the first virtual scene; obtaining a true label, the real label representing a historical candidate PC that is truly selected; respectively embedding the feature data of the historical candidate PC, the feature data of the at least one historical second PC, and the feature data of the historical NPC included in the first virtual scene, to obtain a fourth vector, a fifth vector, and a sixth vector; fusing the fourth vector, the fifth vector, and the sixth vector into a fused vector; and invoking an initialized machine learning model based on the fused vector to perform prediction, to obtain a predicted label, the predicted label representing a predicted probability that the candidate PC is selected; determining a loss based on the true label and the predicted label, and updating parameters of the initialized machine learning model based on the loss, to obtain a trained machine learning model.

Herein, a fully connected layer of the initialized machine learning model is invoked based on the fused vector to perform prediction, to obtain the predicted label; the loss between the true label and the predicted label is determined by using a loss function; and back propagation is performed on the loss, to update the parameters of the initialized machine learning model, the process of calculating the loss and updating the parameters is iterated for several times until a global loss converges, and the iteration process is stopped, to obtain the trained machine learning model. The loss function may be a mean square error loss function, a cross entropy loss function, a multi-label classification loss function, or a triple loss function. Back propagation is implemented by using a back propagation algorithm. A gradient of each neuron is calculated from an output layer to an input layer, a weight and a bias of the neuron are updated based on the gradient, and the parameters are continuously updated in a gradient descent manner, to reduce a loss value. Gradient descent may be implemented by using various gradient descent algorithms, such as a batch gradient descent algorithm, a stochastic gradient descent algorithm, an adaptive gradient descent algorithm, and a momentum gradient descent algorithm.

In the examples of this application, based on the feature data of the candidate PC, the second PC, and the NPC, the probability that the candidate PC is selected is predicted by using the machine learning model, and the first PC is screened out with the goal of defeating the NPC. The machine learning model automatically completes feature analysis, probability calculation, and character selection without the need for manual trial and error of the player, which effectively enhance rationality of character matching and a battle win rate, shortens the preparation time before each round of interaction, ensures smooth and efficient transition from the second virtual scene to the first virtual scene, and optimizes the overall game pace.

Operation 102: Control at least one PC to interact with an NPC.

In some examples, after the at least one PC is teleported to the virtual scene (e.g., the first virtual scene) in which the NPC is located, the at least one PC may be controlled to interact with the NPC.

For example, an auto chess game is used as an example. For a mode in which eight players simultaneously challenge a boss (e.g., the NPC), the eight players need to select, from respective virtual chessboards (e.g., the second virtual scenes), pieces (e.g., the PCs) that participate in battling against Boss battle. After the eight pieces respectively selected by the eight players are teleported to a scene (e.g., the first virtual scene) in which the boss is located, a boss battle round starts. In this case, the boss may launch a group attack skill, to attack (that is, interact with) the eight pieces simultaneously.

In some other examples, when a plurality of the at least one PC exist, a plurality of identifiers (such as avatars and nicknames) in one-to-one correspondence with the plurality of PCs may further be displayed in the first virtual scene. When the plurality of PCs are controlled to interact with the NPC, a damage value of a PC corresponding to each identifier for the NPC may further be displayed in the identifier (such as an area of the avatar).

For example, the auto chess game is used as an example. In a process in which the boss battles against the eight pieces respectively selected by the eight players, avatars of the eight pieces may further be displayed on the screen. For example, the avatars respectively corresponding to the eight pieces may be displayed on a right side of the screen, and damage values of a corresponding piece for the boss may further be displayed in each avatar.

The damage value displayed in the avatar may be updated in real time. As the battle progresses, the damage value displayed in the avatar also changes in real time, that is, the damage value displayed in the avatar is a latest accumulated damage value.

In the examples of this application, by displaying the identifiers in one-to-one correspondence with the plurality of PCs and the real-time damage values, the player can intuitively master a battle contribution and clearly learn a battle situation, whereby timeliness of tactical adjustment is enhanced. The dynamically updated damage value enables the player to perceive combat performance in real time, stimulates a sense of contest, enables the player to actively optimize operations and strive for higher damage per second, whereby immersion and challenge of the game are enhanced, a visual reference is provided for virtual resource allocation after completion of the interaction, and a reward mechanism is persuasive and fair.

In some other examples, following the foregoing example, the following processing may further be performed: ranking, in response to none of the plurality of PCs being defeated by the NPC, the plurality of identifiers based on damage values respectively caused by the plurality of PCs to the NPC. For example, the plurality of identifiers may be ranked in descending order of damage values.

For example, the auto chess game is used as an example. In the boss battle round, if the plurality of pieces (such as the eight pieces) are not defeated by the boss, the eight avatars respectively corresponding to the eight pieces may be ranked in descending order of accumulated damage values caused to the boss. For example, it is assumed that a piece A currently causes a largest accumulated damage value to the boss, an avatar of the piece A ranks first. After a period of time, a piece B causes a largest accumulated damage value to the boss, and an avatar of the piece B may be adjusted to the first place. That is, the ranking result is dynamically adjusted based on the real-time interaction result. In this way, a sense of contest of the player may be further enhanced.

In some examples, following the foregoing example, when a PC is defeated by the NPC in the interaction process, the following processing may further be performed: canceling display of the defeated PC in the first virtual scene, and displaying an identifier corresponding to the defeated PC at a bottom, a display style of the identifier corresponding to the defeated PC being different from a display style of an identifier corresponding to an undefeated PC.

For example, an auto chess game is used as an example. It is assumed that a piece A is defeated by a boss in a boss battle round, that is, a health point of the piece A is reduced to zero, display of the piece A may be canceled, an avatar of the piece A is displayed at a bottom, and meanwhile, the avatar of the piece A may further be grayed out, to prompt a player that the piece A has been defeated. When the piece A is defeated, an accumulated damage value caused by the piece A to the boss is no longer updated.

In some other examples, following the foregoing example, when a plurality of PCs are defeated by the NPC in the interaction process, the following processing may further be performed: ranking a plurality of identifiers respectively corresponding to the plurality of defeated PCs located at the bottom in descending order of damage value caused to the NPC.

For example, the auto chess game is used as an example. If a plurality of pieces are defeated in the boss battle round, a plurality of avatars respectively corresponding to the plurality of defeated pieces located at the bottom may also be ranked in descending order of accumulated damage value caused to the boss. For example, it is assumed that a piece A and a piece B are both defeated by the boss, avatars of the piece A and the piece B may be displayed at a bottom. In addition, it is assumed that an accumulated damage value caused by the piece A to the boss is greater than an accumulated damage value caused by the piece B to the boss, the avatar of the piece A may be located above the avatar of the piece B, that is, the avatar of the piece A is ranked before the avatar of the piece B.

In the examples of this application, identifiers of undefeated PCs are ranked based on damage values, whereby the player learns rankings of battle contributions of the player and others in real time. This stimulates a sense of contest, promotes the player to adjust tactics to increase damage per second, and enhance tension of confrontation. The identifier of the defeated PC is no longer displayed or display at bottom, and the display style is changed, to achieve a clear distinction between surviving and eliminated characters. This enables the player to quickly master a battle field situation, clarify a situation of the player and remaining threats, and adjust tactics in time. In addition, the identifiers of the defeated PCs are then ranked based on the damage values, to provide a more detailed basis for virtual resource allocation after completion of the interaction. This further improves fairness and credibility of results and improves immersion and satisfaction of overall gaming experience.

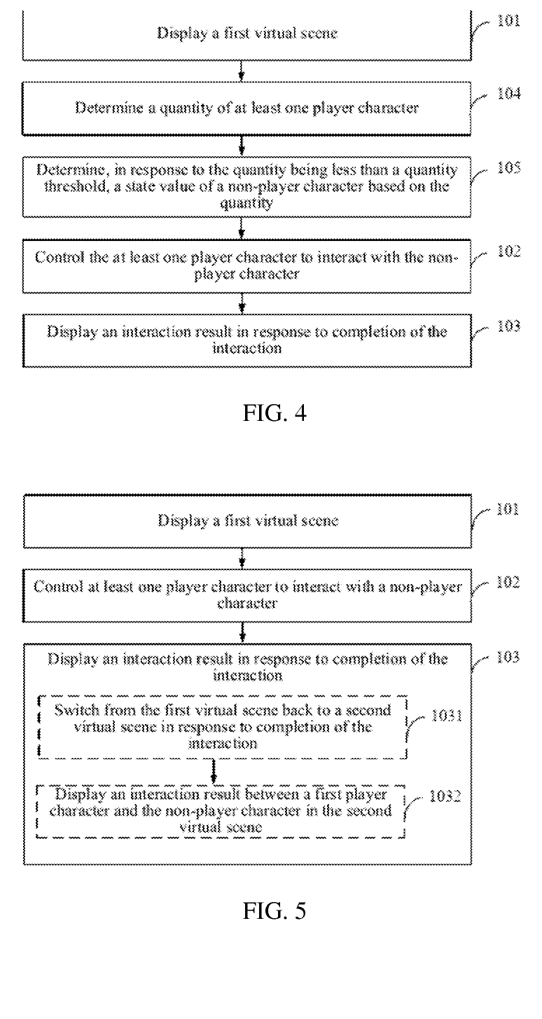

In some examples, FIG. 4 is a second schematic flowchart of an interaction processing method for a virtual scene according to an example of this application. As shown in FIG. 4, before operation 102 shown in FIG. 3 is performed, operation 104 and operation 105 shown in FIG. 4 may further be performed, which are described with reference to operations shown in FIG. 4.

Operation 104: Determine a quantity of the at least one PC.

In some examples, an auto chess game is used as an example. Before a boss battle round starts, a quantity of pieces (e.g., the PCs) teleported to a scene (that is, the first virtual scene) in which a boss is located may be counted, to determine a health point of the boss based on the quantity of fielded pieces. That is, the health point of the boss may be dynamically adjusted based on the quantity of fielded pieces.

Operation 105: Determine, in response to the quantity being less than a quantity threshold, a state value of the NPC based on the quantity.

Herein, the state value (such as a health point, attack power, or defense power of the boss) may be configured for representing difficulty in defeating the NPC. That is, a larger state value of the NPC indicates higher difficulty in defeating the NPC. A smaller state value of the NPC indicates lower difficulty in defeating the NPC.

In some examples, the determining a state value of the NPC based on the quantity may be implemented in the following manner: determining a first difference between a quantity threshold and the quantity; and attenuating an initial state value of the NPC based on the first difference, to obtain an attenuated state value of the NPC.

For example, the auto chess game is used as an example. After the quantity of fielded pieces is obtained, the quantity may be compared with the quantity threshold (such as 8). When the quantity of fielded pieces is less than 8, for example, it is assumed that only four pieces currently participate in a battle, the first difference (that is, 8-4=4) between the quantity threshold and the quantity of currently fielded pieces may be first determined. Next, an initial health point of the boss may be attenuated based on the first difference. For example, it is assumed that the initial health point of the boss is 10000 points, and because only four pieces currently participate in the battle, the health point of the boss may be correspondingly attenuated to 5000 points. That is, in the technical solution provided in the examples of this application, the health point of the boss may be dynamically adjusted based on the quantity of fielded pieces. In this way, compared with a solution in the related art in which the health point of the boss remains unchanged, the technical solution provided in the examples of this application can dynamically adjust difficulty of the Boss based on the quantity of fielded pieces. This prevents the player from frustration caused by a mismatch between game difficulty and the quantity of participants, and further enhancing gaming experience of the player.

In some examples, the "attenuating an initial state value of the NPC based on the first difference, to obtain an attenuated state value of the NPC" may be implemented by performing the following processing: determining a first product of a preset attenuation coefficient and the first difference; determining a second difference between a preset value and the first product; and using a second product of the second difference and the initial state value of the NPC as the attenuated state value of the NPC.

For example, the attenuation coefficient is a preset constant, such as 0.1. In addition, the attenuated state value needs to be greater than or equal to a minimum value of the state value, to avoid excessively low game difficulty. The preset value is a preset constant, such as 1. If the quantity threshold is 5 and the quantity of PCs is 3, the first difference between the quantity threshold and the quantity is 2. If the initial state value of the NPC is 1000 and the attenuation coefficient is 0.1, the first product of the attenuation coefficient and the first difference is 2*0.1=0.2, the second difference between the preset value (such as 1) and the first product is 1-0.2=0.8, and the second product of the second difference and the initial state value of the NPC is 1000*0.8=800, which is used as the attenuated state value of the NPC.

In some examples, different difference intervals correspond to different attenuation percentages. The "attenuating an initial state value of the NPC based on the first difference, to obtain an attenuated state value of the NPC" may be implemented by performing the following processing: determining a target difference interval within which the first difference falls; determining a third difference between the preset value and an attenuation percentage corresponding to the target difference interval; and determining a third product of the third difference and the initial state value, and using the third product as the attenuated state value of the NPC.

For example, a preset mapping relationship between the difference interval and the attenuation percentage may be that: for a difference interval A where a difference is less than or equal to 1, an attenuation percentage is 10%; for a difference interval B where a difference is greater than 1 and less than 4, an attenuation percentage is 25%; and for a difference interval C where a difference is greater than or equal to 4, an attenuation percentage is 40%. If the quantity threshold is 5 and the quantity of PCs is 2, the first difference is 5-2=3, and the first difference falls within the difference interval B. The difference interval B is used as the target difference interval. The attenuation percentage corresponding to the difference interval B is 25%, and the third difference between the preset value (such as 1) and the attenuation percentage corresponding to the difference interval B is 1-25%=75%. The initial state value (such as attack power) is 200, and the third product of the third difference and the initial state value is 200*75%=150, that is, the attenuated state value (such as attack power) of the NPC is 150.

In the examples of this application, the initial state value of the NPC is attenuated based on the first difference between the quantity of PCs and the quantity threshold. When the quantity of PCs is less than the threshold, the state value of the NPC is automatically reduced, to avoid excessively high defeat difficulty caused by excessively few PCs participating in the interaction, ensure rationality of interaction difficulty in scenarios of different quantities of participants, and enhance a challenge success rate and experience of the player. By dynamically calculating the first difference value and attenuating the state value, the difficulty of the NPC can flexibly adapt to a change in the quantity of PCs, to ensure an appropriate level of challenge throughout the interaction process, and enhance universality and inclusion of a game mechanism.

Operation 103: Display an interaction result in response to completion of the interaction.

Herein, the interaction result may include a plurality of interaction metrics (for example, including an accumulated damage value caused to the NPC, and survival duration), and the interaction result may be configured for determining a virtual resource (e.g., a virtual reward, including, for example, virtual equipment and a virtual gold coin) distributed to each PC. The virtual resource may include a plurality of parts (for example, the survival duration corresponds to the virtual gold coin, and the accumulated damage value corresponds to the virtual equipment) in one-to-one correspondence with the plurality of interaction metrics, and a quantity of each part is positively correlated with a rankings of the PC in an interaction metric corresponding to the part. That is, a higher ranking of the player indicates a larger quantity of obtained virtual resources.

In some examples, before the responding to completion of the interaction, the following processing may further be performed: determining completion of the interaction in response to the NPC being defeated; or determining completion of the interaction in response to duration of the interaction between the at least one PC and the NPC reaching a duration threshold (such as 5 minutes)

For example, an auto chess game is used as an example. When a boss in the game is defeated by a piece, it may be considered that a boss battle rounds ends; or when battle duration between the boss and the piece reaches (that is, is greater than or equal to) a duration threshold (such as 5 minutes), it may be considered that the boss battle round ends.

In the examples of this application, the NPC being defeated is used as a condition for determining completion the interaction, to enable the player to clearly perceive achievement of victory and receive virtual resource rewards in time, which reinforces a sense of accomplishment. The interaction duration reaching the threshold is used as a condition for determining completion of the interaction, to ensure a compact game pace, prevent the player from falling into ineffective waiting, and ensure efficient progression of the game process. The two determination manners not only meet requirements of an extreme confrontation in a high-difficulty challenge, but also adapt to time-limited interaction gameplay in a casual entertainment scenario. The two determination manners accommodate players of varying skill levels and different game modes, to enhance universality of the game mechanism. Regardless of strengths of players, the players can achieve interaction goals through proper time control or strategic coordination, whereby the overall participation experience is optimized.

In some other examples, the following processing may further be performed: displaying, in response to the NPC being defeated, an identifier of a PC that defeats the NPC and first prompt information in the first virtual scene, the first prompt information being configured for prompting that the PC that defeats the NPC is to obtain an additional virtual resource. That is, the PC that defeats the NPC may obtain the additional virtual resource in addition to the virtual resource distributed based on the interaction result.

For example, the auto chess game is used as an example. If the boss is defeated in the boss battle round, a name of a piece (for example, is assumed to be a piece A) that defeats the boss and prompt information indicating that a player corresponding to the piece A is to obtain an additional reward may be displayed. That is, the player corresponding to the piece that defeats the boss may obtain the additional reward in addition to a basic reward (such as, an equipment reward corresponding to a damage value and a gold coin reward corresponding to survival duration). A type of the additional reward may be the same as or different from a type of the basic reward. This is not specifically limited in the examples of this application.

In the examples of this application, the identifier of the PC that defeats the NPC is intuitively displayed, whereby a contribution of the PC is visualized in real time, and a sense of accomplishment and gaming experience of the player are reinforced. In addition, the first prompt information clarifies the additional virtual resource reward, which forms an immediate incentive that drives players to actively pursue key defeating contributions, and enhances contest enthusiasm and strategic engagement during the interaction. Display of a combination of the identifier and the prompt information forms a visual focus and information feedback when the NPC is defeated, to further optimize immersion and satisfaction of gaming experience.

In some examples, operation 103 may be implemented in the following manner: displaying an interaction result between the at least one PC and the NPC in the first virtual scene in response to completion of the interaction, the interaction result including a plurality of parts (including, for example, a damage per second ranking and a survival ranking) in one-to-one correspondence with the plurality of interaction metrics.

For example, when a plurality of the at least one PC exist, the displaying an interaction result between the at least one PC and the NPC in the first virtual scene may be implemented in the following manner: the following processing is performed in an area that is included in the first virtual scene and that corresponds to each interaction metric: sequentially displaying, in descending order of rankings of the plurality of PCs in the interaction metric, a plurality of identifiers in one-to-one correspondence with the plurality of PCs.

For example, an example in which the plurality of interaction metrics include an accumulated damage value and survival duration is used. A plurality of avatars in one-to-one correspondence with the plurality of PCs may be ranked in descending order of accumulated damage value on a left side of the first virtual scene. Meanwhile, the plurality of avatars in one-to-one correspondence with the plurality of PCs may further be ranked in descending order of survival duration on a right side of the first virtual scene. In this way, the player may intuitively view the plurality of parts that are in the interaction result and that are in one-to-one correspondence with the plurality of interaction metrics. For example, the player may intuitively learn a damage per second ranking and a survival ranking of the player.

In the examples of this application, the interaction result is presented is a segmented manner based on the plurality of interaction metrics, and the identifiers are presented in the corresponding area of the first virtual scene based on the rankings of the PCs, whereby the player can quickly learn performance of the player and others in different dimensions and intuitively understand a battle contribution and strategic effectiveness. This provides clear reference for subsequent interaction adjustment. Real-time comparison rankings encourage players to actively strive for higher rankings, and enhance a sense of tension and engagement in the interaction process. The multi-metric display recognize dominance directions of different players, and enhances a sense of participation and a sense of accomplishment of all players. The interaction result is presented based on the ranking order, to provide a transparent basis for virtual resource allocation, enable the player to clearly understands logic of a rewarding mechanism, and improve fairness of resource allocation.

In some examples, the at least one PC may include the first PC, and the first PC may be a candidate PC selected from the at least one candidate PC included in the second virtual scene. FIG. 5 is a third schematic flowchart of an interaction processing method for a virtual scene according to an example of this application. As shown in FIG. 5, operation 103 shown in FIG. 3 may be implemented by operation 1031 and operation 1032 shown in FIG. 5, which are described with reference to operations shown in FIG. 5.

Operation 1031: Switch from the first virtual scene back to a second virtual scene in response to completion of the interaction.

In some examples, an auto chess game is used as an example. After a boss battle round ends, switching from a scene (e.g., the first virtual scene) in which the boss is located back to a virtual chessboard (e.g., the second virtual scene) may be performed.

Operation 1032: Display an interaction result between a first PC and the NPC in the second virtual scene.

Herein, the interaction result may include a plurality of parts in one-to-one correspondence with a plurality of interaction metrics. For example, an example in which the plurality of interaction metrics include a damage value and survival duration is used. The interaction result may include a ranking of the first PC in the accumulated damage value caused to the NPC in the interaction process, and a ranking of the first PC in the survival duration in the interaction process.

For example, an example in which the first PC is a piece A is used. After switching from the scene in which the boss is located back to the virtual chessboard is performed, a damage per second ranking and a survival ranking of the piece A in the boss battle round are displayed in the virtual chessboard, such as "You rank first in damage per second and rank third in survival in this team battle".

In the examples of this application, the interaction result is presented after switching from the first virtual scene back to the second virtual scene is performed, to enable the player to directly associate candidate PC selection with actual combat performance, quickly re-evaluate the strengths and weaknesses of character selection strategies, and provide decision reference for a subsequent round. Visual presentation of the multi-metric ranking helps the player comprehensively evaluate performance of the character in different dimensions and precisely position advantages and disadvantages of the character. The scene switching mechanism ensures that the player naturally returns from a combat scene to a character management scene, to avoid information fragmentation and enhance smoothness of the game process.

In some examples, when the interaction result between the first PC and the NPC is displayed in the second virtual scene, the following processing may further be performed: displaying second prompt information and a virtual prop (such as a reward orb) in the second virtual scene, the second prompt information being configured for prompting the player to obtain the virtual resource distributed to the first PC by picking up the virtual prop.

For example, following the foregoing example, in addition to displaying the damage per second ranking and the survival ranking of the piece A in the boss battle round are displayed in the virtual chessboard, the reward orb may further be displayed in the virtual chessboard, and a player prompt is provided, to enable the player to pick up the reward orb according to the prompt to obtain a corresponding reward. The reward may include an equipment reward corresponding to the damage per second ranking and a gold coin reward corresponding to the survival ranking.

In the examples of this application, the player is guided through the second prompt information to pick up the virtual prop, and a virtual resource obtaining process is converted into a visual operation. This avoids monotony of direct reward distribution, enhances perception and anticipation of rewards of the player, and enhances a sense of accomplishment and satisfaction after completion of the interaction. Presentation of the virtual prop achieves visualization of an abstract virtual resource, and the player may obtain the reward through an active picking operation, which enhances a sense of interaction participation. In addition, the prompt information clarifies a mapping relationship between the reward and the interaction metric, which helps the player understand resource obtaining logic, and improves transparency of a game rule.

In some examples, the at least one PC may include the first PC, and a first virtual resource distributed to the first PC may be stored in a database. After operation 103 shown in FIG. 3 is performed, the following processing may further be performed: deleting, in response to the first virtual resource being used, the first virtual resource stored in the database.

For example, an example in which the first PC is a game character A controlled by a player 1. A virtual resource (e.g., the first virtual resource, which may be, for example, virtual equipment) distributed to the game character A may be stored in a database. When it is detected that the player 1 equips the game character A with the virtual equipment, the virtual equipment in the database may be written off, that is, the virtual equipment stored in the database is deleted. This helps prevent a volume of data stored in the database from continuously increasing as the game progresses.

In the solution provided in the related art, virtual resources are randomly distributed, that is, a virtual resource distributed to a PC may be a virtual resource that the PC does not need or is unable to use. Consequently, a data volume of virtual resources stored in the database continuously increases. However, in the technical solution provided in the examples of this application, the virtual resource distributed to the PC is determined based on the interaction result between the PC and the NPC. In this way, it can be ensured that the virtual resource distributed to the PC is a virtual resource that the PC is able to use, e.g., a virtual resource meeting requirements of the PC. In this way, the virtual resource distributed in the game process is more likely to be used. In this case, the virtual resource stored in the database may be written off, to enable precise control over one-time validity of the resource and prevent the virtual resource from being reused or abused. This ensures stability and fairness of an in-game resource system, reduces the data volume of the virtual resources stored in the database, alleviates storage pressure, improves the speed of data retrieval and access, and supports smooth gameplay.

In the interaction processing method for a virtual scene provided in the examples of this application, the virtual resource distributed to the PC is determined based on the interaction result between the PC and the NPC, the virtual resource includes the plurality of parts in one-to-one correspondence with the plurality of interaction metrics, and a quantity of each part is positively correlated with the ranking of the PC in the corresponding interaction metric. In this way, virtual resource distribution manners in a virtual scene are diversified. In addition, the player may select a suitable PC for interaction based on a virtual resource that the player intends to obtain, which improves a sense of contest and gaming experience of the player. By introducing the plurality of interaction metrics, in the process in which the PC interacts with the NPC, a computer system collects multi-dimensional data, performs ranking based on the interaction metrics, and converts rankings into a corresponding quantity of virtual resources. This can measure performance of the player in the interaction process precisely, to improve rationality and fairness of resource allocation.

Next, the following describes exemplary application of the examples of this application in a practical application scenario by using an auto chess game as an example.

In the related art, a player may independently battle against a monster to obtain a corresponding reward, and the reward drops randomly. Rewards that drop for eight players are determined purely based on luck, with some variation, but an overall difference is not significant, whereby the player lacks a sense of contest. In view of this, the examples of this application provide a method for multiplayer simultaneous engagement in a monster team battle. To be specific, eight players may separately select one piece (e.g., the PC) to battle against a monster (e.g., the NPC, such as a boss). The eight pieces engage in the battle together, and rewards are distributed based on damage per second values and final survival states. This enables the players to improve quality of the pieces in a targeted manner. For example, the player may select a piece with extreme damage per second to obtain an accumulated damage reward, or select a piece with high durability (e.g. survivability of the PC, such as an armor value and a health point) to obtain a survival reward. The survival reward and the accumulated damage reward may correspond to equipment and a gold coin, respectively. That is, a piece that survives longer can obtain a better equipment reward, and a piece with higher accumulated damage can obtain more gold coins. In addition, if the boss is finally defeated, a player who defeats the boss may further obtain an additional special reward, which may be, for example, a special reward such as a piece replicator.

That is, the examples of this application provide a monster team battle mode. To be specific, eight players separately select one piece to engage in a battle simultaneously, for example, the eight pieces battle against the boss together in a same scene. In addition, the team battle may be divided into a plurality of rounds, with the boss having lower combat effectiveness in the earlier rounds and becoming increasingly stronger in the later rounds. Battle with the boss may include rewards in three dimensions, which are a damage per second value, survival duration, and defeat, respectively. For the three dimensions, the player may select a targeted piece for a battle, for example, may select a piece with high defense power and health points to obtain a higher survival ranking to obtain a better equipment reward. If the player wants to obtain gold coins to improve economy, the player may select a piece with high damage per second for a battle, to make higher damage to obtain more gold coin rewards. In the earlier rounds where the boss is weak, a piece with a high attack rate may be selected to contend for a defeat reward. The monster team battle mode provided in the examples of this application provides more gameplay strategies, enriches dimensions of gameplay, and enhances enjoyment and a sense of contest.

The following describes the interaction processing method for a virtual scene provided in the examples of this application in detail.

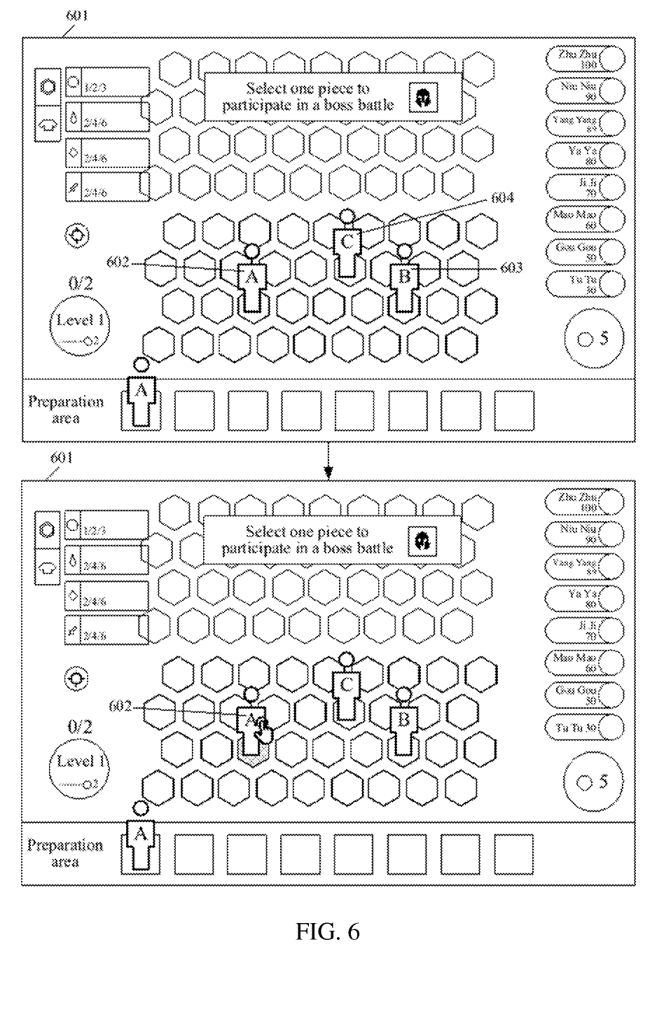

In some examples, FIG. 6 is a schematic diagram of a first application scenario of an interaction processing method for a virtual scene according to an example of this application. As shown in FIG. 6, in a preparation round prior to a boss battle round, a system may prompt a player to select one piece to participate in battling against a boss, that is, the player may select a corresponding piece in a preparation phase to participate in the battle. For example, a plurality of pieces (including, for example, a piece 602, a piece 603, and a piece 604) are displayed in a virtual chessboard 601 for the player to make a selection. It is assumed that the player selects the piece 602 from the plurality of pieces. For example, when a click operation performed by the player for the piece 602 is received, the display state of the piece 602 may be switched from a common state to a highlighted display state, to inform the player that the piece 602 is selected currently.

If the player does not select a piece in the preparation phase, the system (such as a game backend server) may select, by default, a piece with a highest comprehensive attribute in the chessboard to participate in the battle. A determination basis may be an equipment carrying situation of the piece, a star level of the piece, or the like.

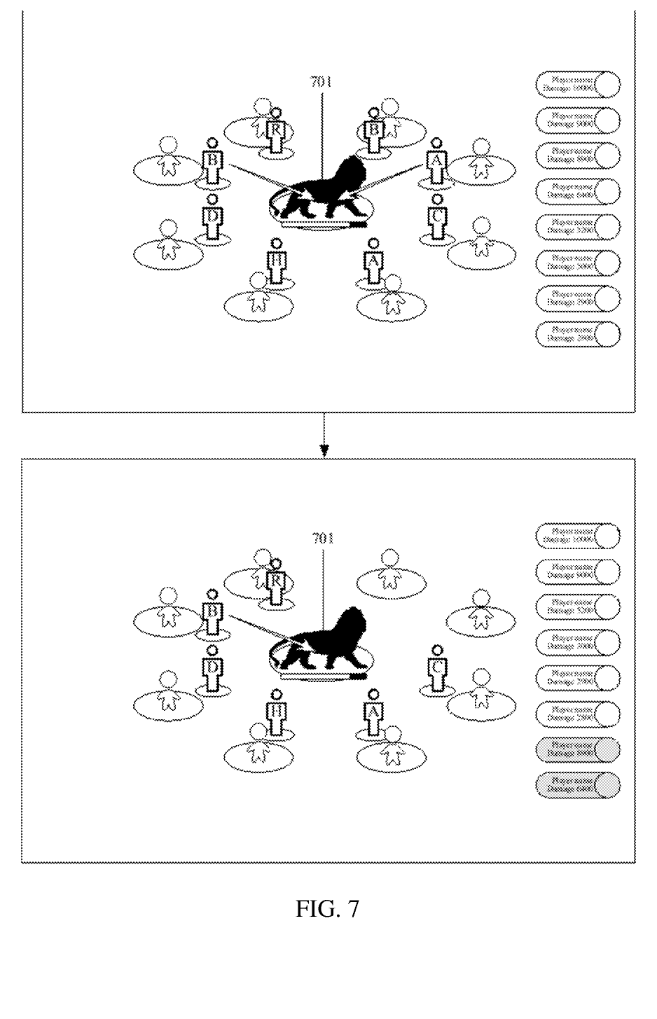

In some other examples, FIG. 7 is a schematic diagram of a second application scenario of an interaction processing method for a virtual scene according to an example of this application. As shown in FIG. 7, after a boss battle round starts, pieces respectively selected by eight players are placed in a field and randomly distributed at eight locations, and the battle starts after the eight pieces are all teleported to the corresponding locations. A monster 701 (e.g., a boss) attacks the eight pieces through an area-of-effect attack, to cause damage to the pieces. In addition, a damage value of a piece controlled by each player to the boss may further be displayed in an avatar area of the player. Surviving pieces are dynamically ranked in descending order of damage value. For example, a piece with higher damage ranks in an upper position, and an avatar of a player whose piece is defeated is displayed at a bottom. In a case that a plurality of pieces are defeated, a plurality of avatars located at the bottom may also be ranked in descending order of damage value. For example, it is assumed that a piece A causes 2000 points of damage to the boss, and a piece B causes 1000 points of damage to the boss. In a case that both the piece A and the piece B are defeated, an avatar of a player corresponding to the piece A is placed above an avatar of a player corresponding to the piece B. In addition, the piece of the player disappears and is no longer displayed after being defeated. For example, the piece B and the piece A that located at an upper right corner disappear from the scene and are no longer displayed after being defeated.

After a piece is defeated, an avatar area of a player corresponding to the piece may alternatively be grayed out, to prompt the player that the current piece has been defeated.

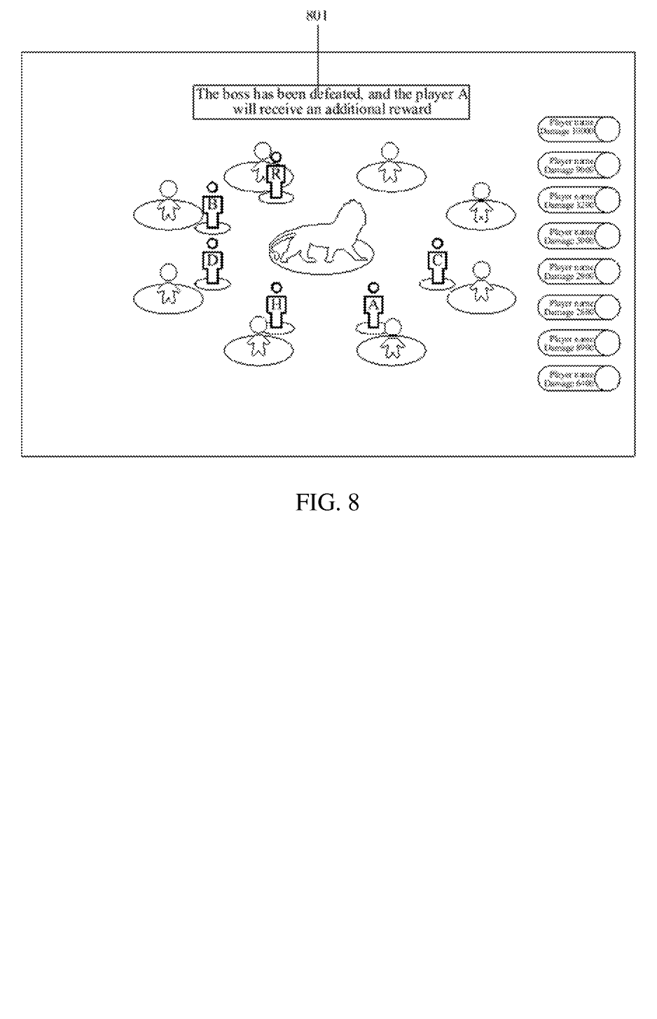

In some examples, FIG. 8 is a schematic diagram of a third application scenario of an interaction processing method for a virtual scene according to an example of this application. As shown in FIG. 8, if a boss is defeated, a player (such as a player A) who defeats the boss and prompt information 801 indicating that the player is to obtain an additional reward may further be displayed. In addition, after a battle ends, gold coin and equipment rewards may be separately calculated based on damage per second rankings and survival rankings. If a player has a piece with highest damage per second, the player may obtain a highest gold reward. If a player has a piece with longest survival duration, the player may obtain a best equipment reward. If a plurality of pieces with longest survival duration exist at the same time, a final survival ranking may be determined with reference to damage values caused by the pieces to the boss.

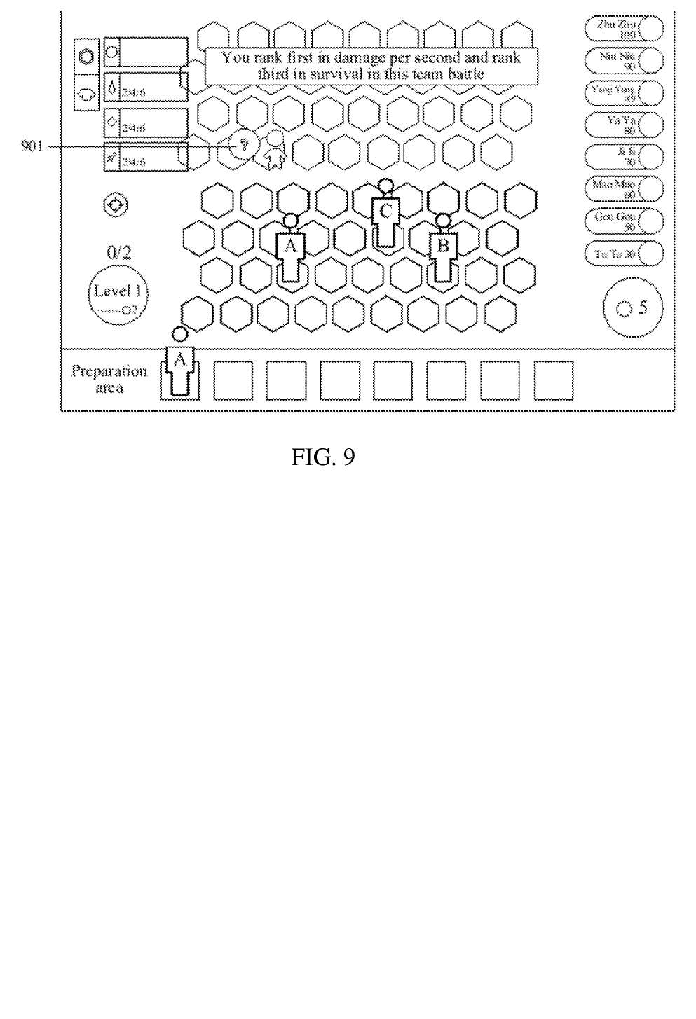

In some other examples, FIG. 9 is a schematic diagram of a fourth application scenario of an interaction processing method for a virtual scene according to an example of this application. As shown in FIG. 9, in a preparation phase after a battle ends, a system may distribute a corresponding reward orb based on a ranking and settlement result, and provide prompt information. A player may obtain, based on the prompt information, a corresponding reward by picking up a reward orb 901 displayed in a virtual chessboard.

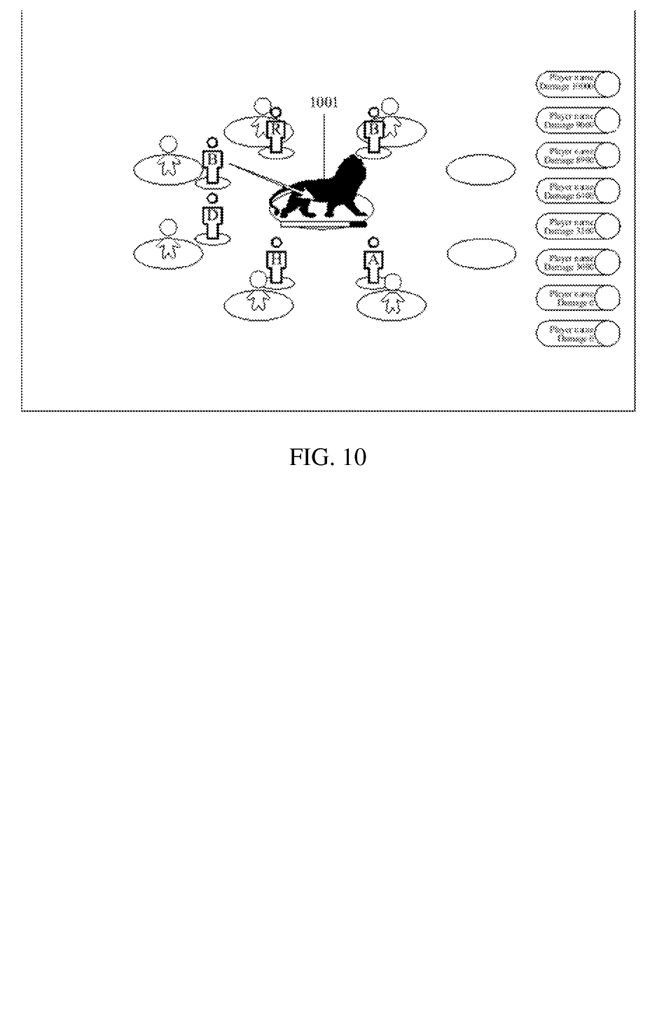

In some examples, FIG. 10 is a schematic diagram of a fifth application scenario of an interaction processing method for a virtual scene according to an example of this application. As shown in FIG. 10, due to an elimination mechanism in an eight-player match where a piece of a player is eliminated once a health point of the piece reaches zero, a situation where fewer than eight pieces participate in a boss battle may occur. Correspondingly, a health point of the boss may be dynamically scaled based on a current quantity of fielded pieces. For example, it is assumed that when eight pieces are fielded, a health point of a boss 1001 (e.g., the boss) is 10000 points, and when only five pieces are fielded for the battle, the health point of the boss may be correspondingly reduced to 7000 points. That is, the health point of the boss may be dynamically adjusted based on a quantity of fielded pieces. This avoids an increase in difficulty in challenging the boss due to a decrease in the quantity of fielded pieces, and improves gaming experience of the player.

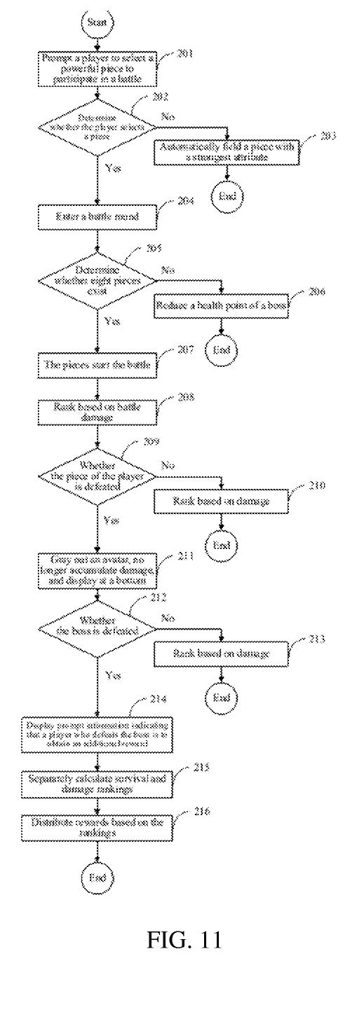

The following describes the interaction processing method for a virtual scene provided in the examples of this application with reference to FIG. 11.

For example, FIG. 11 is a fourth schematic flowchart of an interaction processing method for a virtual scene according to an example of this application. A description is made with reference to operations shown in FIG. 11.

Operation 201: Prompt a player to select a powerful piece to participate in a battle.

In some examples, a client may first determine whether a current round is a preparation round prior to a boss battle round; and if the current round is the preparation round, a control prompting the player to field a piece may be displayed, to prompt the player to select one piece to participate in the battle; or if the current round is not the preparation round, no action is taken.

Operation 202: Determine whether the player selects a piece, and perform operation 203 if the player does not select a piece; or perform operation 204 if the player selects a piece.

Operation 203: Automatically field a piece with a strongest attribute.

In some examples, at the end of a selection phase, the client determines whether the player selects a corresponding piece for a battle. If the player does not select a piece for the battle, the system may determine, based on information such as an equipment carrying situations of pieces, costs of the pieces, and star levels of the pieces, a piece with a highest comprehensive strength in a chessboard, and select the piece by default to participate in the battle. If the player selects a piece, the piece selected by the player participates in the battle.

Operation 204: Enter a battle round.

Herein, switching from a piece selection picture (e.g., a second virtual scene) to a battle picture (e.g., a first virtual scene) is performed, and the selected piece (e.g., a first PC) and a boss (e.g., an NPC) are displayed in the battle picture.

Operation 205: Determine whether eight pieces exist; and perform operation 206 if fewer than eight pieces exist; or perform operation 207 if eight pieces exist.

Operation 206: Reduce a health point of a boss.

In some examples, when the boss battle round starts, the client first determines a current quantity of pieces, and the client uploads the current quantity of pieces to a server. If the current quantity of pieces is less than eight, the server calculates a corresponding attenuation percentage to reduce the health point of the boss. After correcting the health point of the boss, the server feeds back corresponding data to the client, and the client reflects the health point of the boss.

Operation 207: The pieces start the battle.

Herein, pieces selected by different players attack the boss together until the boss is defeated or duration of this game match reaches a duration threshold.

Operation 208: Rank based on battle damage.

For example, a plurality of avatars in one-to-one correspondence with the plurality of pieces may be ranked in descending order of accumulated damage value on a left side of the battle picture.

Operation 209: Determine whether the piece of the player is defeated; and perform operation 210 if the piece of the player is not defeated; or perform operation 211 if the piece of the player is defeated.

Operation 210: Rank based on damage.

Herein, the client may determine rankings of the players based on the damage caused by the pieces controlled by the players to the boss. Higher damage indicates a higher ranking, and lower damage indicates a lower ranking.

Operation 211: Gray out an avatar, no longer accumulate damage, and display at a bottom.

Herein, if a piece is defeated, an avatar of a player may be displayed at the bottom. In a case that a plurality of pieces are defeated, avatars may also be ranked in descending order of damage.

Operation 212: Determine whether the boss is defeated; and perform operation 213 if the boss is defeated; or perform operation 214 if the boss is defeated.

Operation 213: Rank based on damage.

Herein, when the boss is defeated or a round countdown ends, the client may lock a current ranking sequence, and separately determine rankings of survival and damage per second based on a current ranking of the player. When a plurality of surviving pieces exist, the pieces may be ranked based on remaining health points. If the remaining health points are also the same, the pieces may further be ranked based on damage values caused to the boss. A higher damage value caused to the boss indicates a higher ranking.

Operation 214: Display prompt information (e.g., first prompt information) indicating that a player who defeats the boss is to obtain an additional reward (e.g., an additional virtual resource).

Herein, the client may further determine whether the boss is defeated. If the boss is defeated, the client may transmit corresponding information (such as, an identifier of a piece that defeats the boss) to the server. The server allocates, based on the information transmitted by the client, the additional reward to the player who defeats the boss, and feeds the information back to the client, and the client displays a defeat broadcast to prompt all players who defeats the boss.

Operation 215: Separately calculate survival and damage rankings.

In some examples, the plurality of avatars in one-to-one correspondence with the plurality of PCs may be ranked in descending order of accumulated damage value on a left side of the first virtual scene. Meanwhile, the plurality of avatars in one-to-one correspondence with the plurality of PCs may further be ranked in descending order of survival duration on a right side of the first virtual scene.

For example, an example in which the first PC is a piece A is used. After switching from the scene in which the boss is located back to the virtual chessboard is performed, a damage per second ranking and a survival ranking of the piece A in the boss battle round are displayed in the virtual chessboard, such as "You rank first in damage per second and rank third in survival in this team battle".

Operation 216: Distribute rewards based on the rankings.

Herein, in addition to displaying the damage per second ranking and the survival rank of the piece A in the boss battle round in the virtual chessboard, a reward orb (e.g., a virtual prop) may further be displayed in the virtual chessboard, and a player prompt (e.g., second prompt information) is provided, to enable the player to pick up the reward orb based on the prompt to obtain a corresponding reward (e.g., a virtual resource). The reward may include an equipment reward corresponding to the damage per second ranking and a gold coin reward corresponding to the survival ranking.

The interaction processing method for a virtual scene provided in the examples of this application has the following beneficial effects:

The technical solution provided in the examples of this application breaks through limitations of the conventional Player Versus Environment (PVE) mode, transforms fixed distribution of random orb rewards into a more adversarial standalone gameplay mode where players can strategically obtain rewards. Based on requirements and situations of pieces owned by players, a piece with highest damage per second or longest survival duration is strategically selected for obtaining a corresponding reward. The gameplay adds a contest-like nature and tactics to a game. Compared with the original fixed match, a new individual unit development path is provided for players, which allows the players to gain significant rewards by strengthening a single piece and thereby enhances an overall strength of a team.

The following describes an exemplary structure of an interaction processing apparatus 555 for a virtual scene provided in the examples of this application that is implemented as a software module. In some examples, as shown in FIG. 2, software modules in the interaction processing apparatus 555 for a virtual scene that is stored in the memory 550 may include: a display module 5551 and a control module 5552.

The display module 5551 is configured to display a first virtual scene, the first virtual scene including at least one PC and an NPC.

The control module 5552 is configured to control the at least one PC to interact with the NPC.

The display module 5551 is further configured to display an interaction result in response to completion of the interaction, the interaction result including a plurality of interaction metrics, the interaction result being configured for determining a virtual resource distributed to each PC, the virtual resource including a plurality of parts in one-to-one correspondence with the plurality of interaction metrics, and a quantity of each part being positively correlated with a ranking of the PC in an interaction metric corresponding to the part.

In some examples, the at least one PC includes a first PC; and the display module 5551 is further configured to display a second virtual scene before each round of interaction starts, the second virtual scene including at least one candidate PC. The interaction processing apparatus 555 for a virtual scene further includes a determination module 5553, configured to use a selected candidate PC as the first PC in response to a selection operation for the at least one candidate PC. The display module 5551 is further configured to switch from the second virtual scene to the first virtual scene, and display the first PC and the NPC in the first virtual scene.

In some examples, the determination module 5553 is further configured to automatically select one candidate PC from the at least one candidate PC as the first PC in response to not receiving the selection operation for the at least one candidate PC within set duration.

In some examples, the display module 5551 is further configured to highlight, for a target candidate PC in the at least one candidate PC, the target candidate PC in the second virtual scene, the target candidate PC being a candidate PC satisfying a recommendation condition, and the recommendation condition including at least one of the following: an attribute value of a PC reaching an attribute value threshold, a level of the PC reaching a level threshold, or a quantity of equipment of the PC reaching a quantity threshold.

In some examples, the at least one PC includes the first PC and at least one second PC; and the display module 5551 is further configured to display the second virtual scene before each round of interaction starts, the second virtual scene including the at least one candidate PC. The interaction processing apparatus 555 for a virtual scene further includes a prediction module 5554, configured to invoke, for each candidate PC, a machine learning model to perform prediction based on feature data of the candidate PC, feature data of the at least one second PC, and feature data of the NPC included in the first virtual scene, to obtain a probability that the candidate PC is selected, the prediction being performed with the goal of defeating the NPC by the candidate PC and the at least one second PC. The determination module 5553 is further configured to use a candidate PC with a highest probability of being selected as the first PC. The display module 5551 is further configured to switch from the second virtual scene to the first virtual scene, and display the first PC, the at least one second PC, and the NPC in the first virtual scene.

In some examples, when a plurality of the at least one PC exist, the display module 5551 is further configured to display a plurality of identifiers in one-to-one correspondence with the plurality of PCs in the first virtual scene; and configured to display, in each identifier, a damage value caused by a PC corresponding to the identifier to the NPC when the plurality of PCs are controlled to interact with the NPC.

In some examples, the interaction processing apparatus 555 for a virtual scene further includes a ranking module 5555, configured to rank, in response to none of the plurality of PCs being defeated by the NPC, the plurality of identifiers based on damage values respectively caused by the plurality of PCs to the NPC.

In some examples, the display module 5551 is further configured to cancel, in response to any PC being defeated by the NPC, display of the defeated PC in the first virtual scene, and display an identifier corresponding to the defeated PC at a bottom, a display style of the identifier corresponding to the defeated PC being different from a display style of an identifier corresponding to an undefeated PC.

In some examples, the ranking module 5555 is further configured to rank, in response to a plurality of PCs being defeated by the NPC, a plurality of identifiers respectively corresponding to the plurality of defeated PCs located at the bottom in descending order of damage value caused to the NPC.

In some examples, the determination module 5553 is further configured to determine completion of the interaction in response to the NPC being defeated; or configured to determine completion of the interaction in response to duration of the interaction between the at least one PC and the NPC reaching a duration threshold.

In some examples, the display module 5551 is further configured to display, in response to the NPC being defeated, an identifier of a PC that defeats the NPC and first prompt information in the first virtual scene, the first prompt information being configured for prompting that the PC that defeats the NPC is to obtain an additional virtual resource.

In some examples, the determination module 5553 is further configured to determine a quantity of the at least one PC; and determine, in response to the quantity being less than a quantity threshold, a state value of the NPC based on the quantity, the state value being configured for representing difficulty in defeating the NPC.

In some examples, the determination module 5553 is further configured to determine a first difference between the quantity threshold and the quantity; and attenuate an initial state value of the NPC based on the first difference, to obtain an attenuated state value of the NPC.

In some examples, the display module 5551 is further configured to display an interaction result between the at least one PC and the NPC in the first virtual scene in response to completion of the interaction, the interaction result including a plurality of parts in one-to-one correspondence with the plurality of interaction metrics.

In some examples, when a plurality of the at least one PC exist, the display module 5551 is further configured to perform the following processing in an area that is included in the first virtual scene and that corresponds to each interaction metric: sequentially displaying, in descending order of rankings of the plurality of PCs in the interaction metric, a plurality of identifiers in one-to-one correspondence with the plurality of PCs.

In some examples, the at least one PC includes the first PC, and the first PC is a candidate PC selected from the at least one candidate PC included in the second virtual scene; and the display module 5551 is further configured to switch from the first virtual scene back to the second virtual scene in response to completion of the interaction, and display the interaction result between the first PC and the NPC in the second virtual scene, the interaction result including a plurality of parts in one-to-one correspondence with the plurality of interaction metrics.

In some examples, the display module 5551 is further configured to display second prompt information and a virtual prop in the second virtual scene when the interaction result between the first PC and the NPC is displayed, the second prompt information being configured for prompting the first PC to obtain a virtual resource distributed to the first PC by picking up the virtual prop.

In some examples, the at least one PC includes the first PC, and a first virtual resource distributed to the first PC is stored in a database; and the interaction processing apparatus 555 for a virtual scene further includes a deletion module 5556, configured to delete, in response to the first virtual resource being used, the first virtual resource stored in the database.

The description of the apparatus in the examples of this application are similar to the foregoing description of the method examples, and have beneficial effects similar to those of the method examples. Therefore, details are not described again. Technical details not mentioned in the interaction processing apparatus for a virtual scene provided in the examples of this application may be understood based on the description of any one of FIG. 3, FIG. 4, and FIG. 5.

Examples of this application provide a computer program product. The computer program product includes a computer program or computer-executable instructions. The computer program or computer-executable instructions are stored in a computer-readable storage medium. A processor of a computer device reads the computer-executable instructions from the computer-readable storage medium, and executes the computer-executable instructions, to cause the computer device to perform the interaction processing method for a virtual scene according to the examples of this application.

Examples of this application provide a computer-readable storage medium, having computer-executable instructions stored therein. The computer-executable instructions, when executed by a processor, cause the processor to perform the interaction processing method for a virtual scene according to the examples of this application, such as the interaction processing method for a virtual scene shown in FIG. 3, FIG. 4, or FIG. 5.

In some examples, the computer-readable storage medium may be a memory such as a ferroelectric RAM (FRAM), a ROM, a programmable ROM (PROM), an erasable PROM (EPROM), an electrically EPROM (EEPROM), a flash memory, a magnetic surface memory, an optical disk, or a compact disc ROM (CD-ROM); or may be any device including one of or any combination of the foregoing memories.

In some examples, the executable instructions may take the form of a program, software, a software module, a script, or code, written in any form of programming language (including compiled or interpreted languages, or declarative or procedural languages), and may be deployed in any form, including as a stand-alone program or as a module, component, subroutine, or another unit suitable for use in a computing environment.

For example, the executable instructions may be deployed to be executed on one electronic device, or on a plurality of electronic devices located at one location, or on a plurality of electronic devices distributed at a plurality of locations and interconnected through a communication network.

The foregoing are merely examples of this application and is not intended to limit the scope of protection of this application. Any modification, equivalent replacement, or improvement made within the spirit and scope of this application fall within the scope of protection of this application.

What is claimed is:

1. An interaction processing method for a virtual scene, applied to an electronic device, the method comprising: displaying a first virtual scene, the first virtual scene comprising at least one player character (PC) and a non-player character (NPC); controlling the at least one PC to interact with the NPC; displaying an interaction result in response to completion of the interaction, the interaction result comprising a plurality of interaction metrics; and determining, based on the interaction result, a virtual resource distributed to the at least one PC, the virtual resource comprising a plurality of parts, each part corresponding to a respective one of the plurality of interaction metrics, and a quantity of each part being positively correlated with a ranking of the at least one PC in the respective interaction metric.

2. The method according to claim 1, wherein: the at least one PC comprises a first PC; and before the displaying the first virtual scene, the method further comprises: displaying a second virtual scene before each round of interaction starts, the second virtual scene comprising at least one candidate PC; and using a selected candidate PC as the first PC in response to a selection operation for the at least one candidate PC; and the displaying the first virtual scene comprises:switching from the second virtual scene to the first virtual scene, and displaying the first PC and the NPC in the first virtual scene.

3. The method according to claim 2, after the displaying the second virtual scene, further comprising: automatically selecting one candidate PC from the at least one candidate PC as the first PC in response to not receiving the selection operation for the at least one candidate PC within a set duration.

4. The method according to claim 2, after the displaying the second virtual scene, further comprising: highlighting, for a target candidate PC in the at least one candidate PC, the target candidate PC in the second virtual scene, the target candidate PC being a candidate PC satisfying a recommendation condition, and the recommendation condition comprising at least one of the following: an attribute value of a PC reaching an attribute value threshold, a level of the PC reaching a level threshold, or a quantity of equipment of the PC reaching a quantity threshold.

5. The method according to claim 1, wherein: the at least one PC comprises a first PC and at least one second PC; before the displaying the first virtual scene, the method further comprises: displaying a second virtual scene before each round of interaction starts, the second virtual scene comprising at least one candidate PC; invoking, for each candidate PC, a machine learning model to perform prediction based on feature data of the candidate PC, feature data of the at least one second PC, and feature data of the NPC comprised in the first virtual scene, to obtain a probability that the candidate PC is selected, the prediction being performed with a goal of defeating the NPC by the candidate PC and the at least one second PC; and using a candidate PC with a highest probability of being selected as the first PC; and the displaying the first virtual scene comprises: switching from the second virtual scene to the first virtual scene, and displaying the first PC, the at least one second PC, and the NPC in the first virtual scene.

6. The method according to claim 5, wherein the invoking the machine learning model comprises: embedding the feature data of the candidate PC, to obtain a first vector; embedding the feature data of the at least one second PC, to obtain a second vector; embedding the feature data of the NPC comprised in the first virtual scene, to obtain a third vector; fusing the first vector, the second vector, and the third vector into a to-be-predicted vector; performing feature extraction on the to-be-predicted vector by using the machine learning model, to obtain a deep feature of the to-be-predicted vector; and mapping the deep feature to the probability that the candidate PC is selected.

7. The method according to claim 1, wherein: when a plurality of the at least one PC exist, after the displaying the first virtual scene, the method further comprises:displaying a plurality of identifiers in one-to-one correspondence with the plurality of PCs in the first virtual scene; and displaying, in each identifier, a damage value caused by a PC corresponding to the identifier to the NPC when the plurality of PCs are controlled to interact with the NPC.

8. The method according to claim 7, further comprising: ranking, in response to none of the plurality of PCs being defeated by the NPC, the plurality of identifiers based on damage values respectively caused by the plurality of PCs to the NPC.

9. The method according to claim 7, further comprising: canceling, in response to one of the plurality of PCs being defeated by the NPC, display of the defeated PC in the first virtual scene, and displaying an identifier corresponding to the defeated PC at a bottom, a display style of the identifier corresponding to the defeated PC being different from a display style of an identifier corresponding to an undefeated PC.

10. The method according to claim 9, further comprising: ranking, in response to the plurality of PCs being defeated by the NPC, a plurality of identifiers respectively corresponding to the plurality of defeated PCs located at the bottom in descending order of damage value caused to the NPC.

11. The method according to claim 1, further comprising: determining completion of the interaction in response to the NPC being defeated; or determining completion of the interaction in response to duration of the interaction between the at least one PC and the NPC reaching a duration threshold.

12. The method according to claim 1, further comprising: displaying, in response to the NPC being defeated, an identifier of a PC that defeats the NPC and first prompt information in the first virtual scene, the first prompt information being configured for prompting that the PC that defeats the NPC is to obtain an additional virtual resource.

13. The method according to claim 1, before the controlling the at least one PC to interact with the NPC, further comprising: determining a quantity of the at least one PC; and determining, in response to the quantity being less than a quantity threshold, a state value of the NPC based on the quantity, the state value being configured for representing difficulty in defeating the NPC.

14. The method according to claim 13, wherein the determining a state value of the NPC based on the quantity comprises: determining a first difference between the quantity threshold and the quantity; and attenuating an initial state value of the NPC based on the first difference, to obtain an attenuated state value of the NPC.

15. The method according to claim 14, wherein the attenuating the initial state value of the NPC based on the first difference, to obtain an attenuated state value of the NPC comprises: determining a first product of a preset attenuation coefficient and the first difference; determining a second difference between a preset value and the first product; and using a second product of the second difference and the initial state value of the NPC as the attenuated state value of the NPC.

16. The method according to claim 14, wherein the attenuating the initial state value of the NPC based on the first difference, to obtain an attenuated state value of the NPC comprises: determining a target difference interval within which the first difference falls; determining a third difference between a preset value and an attenuation percentage corresponding to the target difference interval, different difference intervals corresponding to different attenuation percentages; and determining a third product of the third difference and the initial state value, and using the third product as the attenuated state value of the NPC.

17. The method according to claim 1, wherein the displaying an interaction result in response to completion of the interaction comprises: displaying an interaction result between the at least one PC and the NPC in the first virtual scene in response to completion of the interaction, the interaction result comprising a plurality of parts in one-to-one correspondence with the plurality of interaction metrics.

18. An interaction processing apparatus for a virtual scene, comprising: one or more processors; and memory storing instructions that, when executed by the one or more processors, cause the interaction processing apparatus to: display a first virtual scene, the first virtual scene comprising at least one player character (PC) and a non-player character (NPC); control the at least one PC to interact with the NPC; display an interaction result in response to completion of the interaction, the interaction result comprising a plurality of interaction metrics; and determine, based on the interaction result, a virtual resource distributed to the at least one PC, the virtual resource comprising a plurality of parts, each part corresponding to a respective one of the plurality of interaction metrics, and a quantity of each part being positively correlated with a ranking of the at least one PC in the respective interaction metric.

19. The interaction processing apparatus for the virtual scene according to claim 18, wherein: the at least one PC comprises a first PC; and before displaying the first virtual scene, the instructions, when executed by the one or more processors, cause the interaction processing apparatus to: display a second virtual scene before each round of interaction starts, the second virtual scene comprising at least one candidate PC; use a selected candidate PC as the first PC in response to a selection operation for the at least one candidate PC; and display the first virtual scene by switching from the second virtual scene to the first virtual scene, and display the first PC and the NPC in the first virtual scene.

20. A non-transitory computer-readable storing instructions that, when executed, cause an interaction processing apparatus for a virtual scene to: display a first virtual scene, the first virtual scene comprising at least one player character (PC) and a non-player character (NPC); control the at least one PC to interact with the NPC; display an interaction result in response to completion of the interaction, the interaction result comprising a plurality of interaction metrics; and determine, based on the interaction result, a virtual resource distributed to the at least one PC, the virtual resource comprising a plurality of parts, each part corresponding to a respective one of the plurality of interaction metrics, and a quantity of each part being positively correlated with a ranking of the at least one PC in the respective interaction metric.
